(19) United States
(12) Patent Application Publication
(10) Pub. No.: US 2020/0369891 A1
(43) Pub. Date: Nov. 26, 2020

(54) EFFECT PIGMENTS

(71) Applicant: Merck Patent GmbH, Darmstadt (DE)

(72) Inventors: Lukas HAMM, Otzberg (DE); Carsten HANDROSCH, Ober-Ramstadt (DE); Nicole NELISCHER, Gross-Bieberau (DE); Nicole HAFERKORN, Pfungstadt (DE)

(73) Assignee: Merck Patent GmbH, Darmstadt (DE)

(21) Appl. No.: 16/956,050

(22) PCT Filed: Dec. 17, 2018
(86) PCT No.: PCT/EP2018/085140

§ 371 Date: Jun. 19, 2020

(30) Foreign Application Priority Data
Dec. 20, 2017 (DE) 10 2017 011 800.0

(51) Int. Cl. C09C 1/00; C03C 8/20; C03C 8/02

(52) U.S. Cl. CPC C09C 1/0051; C09C 1/0018; C09C 1/0021; C03C 8/20; C09C 2200/401; C09C 2200/303; C09C 2200/102; C09C 2200/1004; C03C 8/02

(57) ABSTRACT

The invention relates to glaze- and enamel-stable effect pigments having a top layer comprising at least one tin/antimony mixed oxide, which have improved stability, in particular at temperatures above 1000° C., in glazes, enamels, ceramic or glass-like materials.

The invention relates to glaze- and enamel-stable effect pigments having a top layer comprising at least one tin/antimony mixed oxide, which have improved stability, in particular stable at temperatures above 1000° C., in glazes, enamels, ceramic or glass-like materials.

In general, mixtures of effect pigments, for example pearlescent pigments, and ceramic frits are employed for decorative applications in ceramic glazes. In particular on use for ceramic glazes in the high-temperature range above 1000° C., as are specifically also employed in the so-called single firing process, the problem occurs that the effect pigments do not withstand the aggressive conditions consisting of oxidic melt (frit components) and high temperatures during the firing process without damage. Attempts have therefore been made in the past to stabilise the effect pigments by sheathing with insulating protective layers for such applications. A second approach for stabilisation is an appropriate combination of frit and pearlescent pigment.

It is known from the prior art that a significant loss of tinting strength and pearlescent effect must be expected on use of pearlescent pigments in ceramic glazes in the use range of >1000° C. In order to prevent this, these pigments must either be encapsulated in additional protective layers, or the use of pearlescent pigments in this high-temperature area of application is limited to iron oxide-coated pearlescent pigments in especially modified engobes or fluxes.

EP 220 509 A1 describes, for example, the stabilisation of pearlescent pigments by means of SnO₂ and/or CeO₂ layers.

EP 307 771 A1 discloses the encapsulation of pearlescent pigments with Au-doped SnO₂ layers for combination of stabilisation and novel decorative effects. In order to achieve the desired stabilisation, substantial amounts of the said oxides/oxide combinations must be applied in both cases. Thus, it has proven advantageous to apply the protective coating in amounts of about 5-30% by weight, based on the entire pigment.

DE 39 32 424 C1 discloses pearlescent pigment/frit combinations with and without additional absorptive pigments. The range of use of the pigmented glass frit is, however, only a maximum of 700-900° C.

GB 2 096 593 A describes the use of pearlescent pigments in ceramic fluxes comprising frits. Neither the target firing temperature nor the particular problems on use of pearlescent pigments at temperatures of >1000° C. is discussed here.

U.S. Pat. No. 5,783,506 describes the use of TiO₂- or Fe₂O₃-coated mica pigments in “leafing”-capable ceramic fluxes, i.e. formulations consisting of frit, dispersant, binder, mica and pearlescent pigment based on mica, of a defined viscosity. The invention in this US patent consists in that the addition of mica causes the pearlescent pigments to migrate to the surface of the glaze (leafing).

U.S. Pat. No. 4,353,991 discloses the use of pearlescent pigments having a particle size of 1-200 μm in “fritted glass enamel” in a concentration range from 0.5 to 25.0% by weight, based on the mass of the frit/pigment mixture. However, the range of use these mixtures is only possible at temperatures up to a maximum of 538-760° C.

EP 0 419 843 A1 describes the use of pearlescent pigments in a use concentration of 5-20% weight in a glass frit. For the use temperature, 800-900° C. is quoted for fast firing or 700-800° C. for normal firing.

CN 101462895A discloses the use of 10-60% by weight of golden pearlescent pigments in glazes at 1000-1200° C. The frit employed here is composed of

### SiO₂: 55˜80%

Al₂O₃: 5˜20%

### CaO: 0.5-3%

### MgO: 0-2%

### Na₂O: 1˜5%

### K₂O: <5%

B₂O₃: 3˜15%.

It is disadvantageous here that the use is restricted exclusively to specific gold-coloured pearlescent pigments based on mica, with the layer structure of the gold-coloured pearlescent pigments not being disclosed. The number and colour selection of the pigments that can be employed is therefore very greatly restricted in CN 101462895A.

DE 198 59 420 A1 discloses modified engobes having a pearlescent effect. The coating of clay and ceramic products for improving (priming) the surface through fineness or colour is usually carried out using engobes. Due to the modified engobes, better adhesion of the engobe to the fired or unfired tile, clay or ceramic products is achieved. The engobe comprises a frit for the firing range from 600-1200° C. and one or more pearlescent pigments.

A further patent application which is concerned with improving the pearlescent effect owing to technical changes in the application and composition of the pigment/frit mixture is EP 3 159 380 A1.

Effective and universal protecting layers for use of effect pigments, such as, for example, pearlescent pigments, for example in glazes, enamels, ceramic or glass-like materials, where temperatures ≥1000° C. are used and stabilisation is achieved compared with the unprotected pigment without technical changes in connection with the application, such as, for example, the change in the frit composition, are not known from the prior art.

The object of the present invention is therefore to stabilise effect pigments in such a way that they are stable at temperatures ≥1000° C. and can therefore be employed without problems, for example, in ceramic bodies and paints, decorative glazes, enamels, etc., and at the same time the optical properties of the effect pigments are only impaired insignificantly, or not at all, by the stabilisation.

Since antimony as dopant is usually incorporated permanently into the crystal structure of cassiterite, it is furthermore ensured that leaching-out of Sb ions in contact with eluting liquids does not occur. In particular for use in ceramic products for food contact, this is an important property.

The aim is for stabilisation to be achieved here exclusively by the protecting layer, without it being necessary to make modifications to the frit or the workpiece production process.

Surprisingly, it has been found that pigments coated with tin/antimony mixed oxides have significantly improved stability in ceramic applications compared with the stabilised effect pigments from the prior art. In particular, effect pigments, such as, for example, pearlescent pigments, based on flake-form substrates, containing at least one layer comprising TiO₂ and/or titanium oxynitride and/or other titanium-containing mixed oxides and optionally further layers, are stabilised if they have a top layer comprising a tin/antimony mixed oxide on the surface. Due to this top layer, the effect pigment is stable to temperatures ≥1000° C. and can be incorporated without problems into enamels, glazes, clay and ceramic products, etc., without impairing the optical properties. Furthermore, the stabilised pigments exhibit no leaching-out of Sb ions, which is advantageous for use in ceramics with food contact.

The present invention therefore relates to effect pigments based on flake-form substrates which are distinguished by the fact that they are provided with a top layer comprising one or more tin/antimony mixed oxides of the formula SnₓSb₁₋ₓO₂, where x is a number between 0 and 1, in order to achieve improved heat and temperature stability in glazes, ceramics, enamels, etc.

The invention furthermore also relates to formulations, coatings, tiles, enamels, glazes, clay, glass and ceramic products which comprise the effect pigment stabilised in accordance with the invention.

Wet-chemical coating of flake-form substrates with tin oxide and antimony oxide is known and is described, inter alia, in the following patent applications: DE 42 37 990 A1 or DE 38 42 330 A1. The pigments coated in this way are distinguished by their electrical properties, as known, for example, from DE 10 2010 052 888 A1, or by their interactions with electromagnetic waves. Furthermore, pigments having a structure of this type play a role in heat reflection, as described, for example, in DE 198 56 171 A1, in brightness, as described, for example, in EP 0 139 557 A1, or as absorbers in laser marking, as known, for example, from DE 44 15 802 A1. The said pigments are functional pigments which have no colouristic properties.

The coating of effect pigments with one or more mixed oxides comprising tin/antimony leads to significantly improved stability of the pigments in ceramic applications compared with the unstabilised pigments. This stabilisation is evident, in particular, at firing temperatures of 600-1200° C., but particularly preferably at temperatures of 1000-1200° C.

The top layer comprising tin/antimony oxide here is a mixed oxide of tin oxide and antimony oxide which is described by the formula SnₓSb₁₋ₓO₂. x is a number between 0 and 1. In a preferred embodiment, x denotes a number between 0.5 and 0.9. In this range, antimony is the dopant, which is incorporated into the cassiterite crystal structure which is usual for SnO₂. This can be demonstrated by means of x-ray diffraction. In a preferred embodiment, the SnO₂ is in the cassiterite structure.

Tin/antimony oxide is known as Pigment Black 23 and, besides this use, is employed in industry mainly owing to its semiconducting properties.

For stabilisation, the effect pigments are preferably coated on the surface with, depending on the nature of the effect pigment to be stabilised and/or the corresponding particle-size fraction, 1-100% by weight, in particular with 5-60% by weight and very particularly preferably with 20-50% by weight, based on the effect pigment, with a tin/antimony mixed oxide of variable composition.

Depending on the particle size, the top layer on the effect pigment generally has a thickness of 1-500 nm, in particular 1-100 nm and very particularly preferably of 2-70 nm.

Top layer in this patent application is taken to mean the complete coating of the surface of an effect pigment.

The application of the top layer to the effect pigment can be carried out relatively simply and easily. The tin/antimony oxide used for the stabilisation is preferably applied to the effect pigment from one or more soluble tin and antimony salts by wet-chemical precipitation reaction. Subsequent calcination of the coated effect pigment at temperatures of 250-1000° C. gives effect pigments which are coated on the surface with one or more tin/antimony mixed oxides.

In the case of wet coating, the effect pigments are suspended in water, and one or more hydrolysable tin or antimony salts, preferably tin(IV) salts, such as, for example, SnCl₄, and antimony(III) salts, such as, for example, SbCl₃, a pH which is suitable for hydrolysis, which is selected so that the tin/antimony oxide or tin/antimony oxide hydrate is precipitated directly onto the effect pigments, without secondary precipitations occurring. The pH is usually kept constant by simultaneous metered addition of a base and/or acid. The effect pigments are subsequently separated off, washed and dried and optionally calcined. In general, the calcination temperatures are in the range from 250-1000° C., preferably 350-900° C. If desired, the pigments can finally also be sieved in order to set the corresponding particle size.

In general, the coating is carried out by joint precipitation of the tin and antimony salts. However, it is also possible to apply one or more tin oxide or tin oxide hydrate layers and one or more antimony oxide or antimony oxide hydrate layers. In this case, the tin/antimony mixed oxide is obtained by subsequent calcination at a suitable temperature.

The preparation is in principle also possible in a one-pot process, in which the coating with the tin/antimony oxide according to the invention is carried out in direct sequence during the preparation process of the effect pigment itself (coating of a substrate flake with titanium dioxide and further oxides), without the effect pigment, consisting of a substrate flake coated with titanium dioxide and further oxides, being calcined in advance.

Furthermore, the coating can also take place in a fluidised-bed reactor by gas-phase coating, where, for example, the processes proposed in EP 0 045 851 and EP 0 106 235 for the preparation of pearlescent pigments can be used correspondingly.

For this purpose, it is possible to employ, for example, the following Sb-containing precursor, which hydrolyse with H₂O vapour: SbCl₃, SbF₃, Sb(III) n-butoxide, Sb(III) ethoxide or tris(dimethylamino)antimony. Suitable Sn-containing precursors are, for example: tetrakis(dimethylamino)-tin(IV), Sn(acac)₂, bis(N,N′-di-i-propylacetamidinato)tin(II), N,N′-di-t-butyl-2,3-diamidobutanetin(II) or bis(N,N′-di-i-propylacetamidinato)tin(II).

Depending on the calcination temperature and amount or ratio of the starting materials employed, a coating of

SnₓSb₁₋ₓO₂, where x=0.9,
SnₓSb₁₋ₓO₂, where x=0.7,
SnₓSb₁₋ₓO₂, where x=0.5,
SnₓSb₁₋ₓO₂, where x=0.3,
SnₓSb₁₋ₓO₂, where x=0.1,
is located on the surface of the effect pigment.

Particularly preferred effect pigments are provided on the surface with a tin/antimony mixed oxide of the formula SnₓSb₁₋ₓO₂, where x=0.6 or x=0.9.

The present invention also relates to a process for the preparation of the effect pigments stabilised in accordance with the invention.

The effect pigments to be stabilised are preferably pearlescent pigments, interference pigments, multilayered pigments having transparent, semi-transparent and/or opaque layers, holographic pigments. A particularly stabilising effect is achieved in the case of interference or silver-white effect pigments consisting of a flake-form substrate coated with TiO₂ and/or titanium oxynitride and/or other titanium-containing mixed oxides and optionally further layers.

Titanium oxynitride in this application is taken to mean compounds of the formula TiOₓN_{y}, where x=0-2 and y=0-1 and 1≤x+y≤2 always applies.

Particular preference is given to effect pigments which have at least one layer comprising TiO₂. If a titanium oxynitride (TiOₓN_{y}) is present, oxynitrides where x>1.5 and y<0.5 are particularly preferred. The layer comprising titanium oxynitride may also be a mixture of two or more titanium oxynitride compounds or other titanium-containing mixed oxides. The titanium oxynitride compounds here can be mixed with one another in any ratio.

Suitable effect pigments are, in particular, pearlescent pigments, interference pigments or multilayered pigments having transparent, semitransparent and/or layers based, in particular, on supports, where this is preferably in flake form, such as, for example, phyllosilicate flakes. For example, flake-form TiO₂, synthetic (for example fluorophlogopite or Zn phlogopite) or natural mica, muscovite, sericite, doped or undoped glass flakes, flake-form SiO₂, flake-form BN, flake-form SiC, flake-form Al₂O₃ or flake-form iron oxide are suitable. The glass flakes can consist of all glass types known to the person skilled in the art, for example of A glass, E glass, C glass, ECR glass, recycled glass, window glass, borosilicate glass, Duran® glass, labware glass or optical glass. The refractive index of the glass flakes is preferably 1.45-1.80, in particular 1.50-1.70. The glass substrates particularly preferably consist of C glass, ECR glass or borosilicate glass.

Also particularly suitable are high-temperature-resistant flakes, such as, for example, Al₂O₃, SiC, TiC, WC, B₄C, BN, graphite, TiO₂ and Fe₂O₃ flakes.

Suitable substrate flakes for the effect pigments, in particular pearlescent pigments, can be doped or undoped. If they are doped, the doping is preferably Al, N, B, Ti, Zr, Si, In, Sn, or Zn or mixtures thereof. Furthermore, further ions from the group of the transition metals (V, Cr, Mn, Fe, Co, Ni, Cu, Y, Nb, Mo, Hf, Ta, W) and ions from the group of the lanthanides can serve as dopants.

In the case of Al₂O₃, the substrate is preferably undoped or doped with TiO₂, ZrO₂ or ZnO. The Al₂O₃ flakes are preferably corundum. Suitable Al₂O₃ flakes are preferably doped or undoped α-Al₂O₃-flakes, in particular TiO₂-doped α-Al₂O₃ flakes. If the substrate is doped, the proportion of the doping is preferably 0.01-5.00% by weight, in particular 0.10-3.00% by weight, based on the substrate.

The size of the support substrates is not crucial per se and can be matched to the particular application. In general, the flake-form substrates have a thickness of 0.1 to 5 μm, in particular 0.2 to 4.5 μm and very particularly preferably of 0.2 to 2 μm. The dimension in the other two ranges is usually 1 to 1000 μm, preferably 2 to 200 μm, and in particular 5 to 60 μm.

Typical examples of particle size distributions are:

D₁₀: 1-50 μm, in particular 2-45 μm, very particularly preferably 5-40 μm
D₅₀: 7-275 μm, in particular 10-200 μm, very particularly preferably 15-150 μm
D₉₀: 15-500 μm, in particular 25-400 μm, very particularly preferably 50-200 μm.

The effect pigments mentioned in the following table, all of which are commercially available, can be stabilised, for example, by the process according to the invention using one or more tin/antimony mixed oxides. The table shows the compositions of these effect pigments and, in the “Particle sizes” column, in each case the d₁₀-d₉₀ value measured using Malvern Mastersizer 2000 instrument:

| | | | | Particle |
|---|---|---|---|---|
| | | | | size |
| Trade name | Manufacturer | Substrate | Coating | [μm] |
| Xirallic © Crystal | Merck KGaA | Al₂O₃ | TiO₂ | 5-35 |
| Silver | | | | |
| lriodin © 103 | Merck KGaA | Natural mica | TiO₂ | 10-60 |
| lriodin © 9219 | Merck KGaA | Natural mica | TiO₂ | 10-60 |
| SynCrystal © Silver | Eckart GmbH | Synthetic mica | TiO₂ | 10-50 |
| SYMIC © B001 | Eckart GmbH | Synthetic mica | TiO₂ | 5-25 |
| Silver | | | | |
| SYMIC © C001 | Eckart GmbH | Synthetic mica | TiO₂ | 10-40 |
| Silver | | | | |
| SYMIC © C604 | Eckart GmbH | Synthetic mica | TiO₂ | 10-40 |
| Silver | | | | |
| SYMIC © OEM | Eckart GmbH | Synthetic mica | TiO₂ | 3-15 |
| X-fine Silver | | | | |
| Magnapearl © 1000 | BASF AG | Natural mica | TiO₂ | 6-48 |
| Magnapearl © 2000 | BASF AG | Natural mica | TiO₂ | 5-25 |
| Magnapearl © 3100 | BASF AG | Natural mica | TiO₂ | 2-10 |
| Lumina © Exterior | BASF AG | Natural mica | TiO₂ | 8-48 |
| Gold 2303D | | | | |
| Lumina © Royal | BASF AG | Natural mica | TiO₂ | 10-34 |
| Copper | | | | |
| Lumina © Royal | BASF AG | Natural mica | TiO₂ | 10-34 |
| Magenta | | | | |
| Lumina © Royal | BASF AG | Natural mica | TiO₂ | 10-34 |
| Blue | | | | |
| Exterior Polar | Fujian Kuncai | Natural mica | TiO₂ | 5-25 |
| White | Fine | | | |
| KC9119-SW | Chemicals | | | |
| | Co., Ltd. | | | |
| Exterior Sterling | Fujian Kuncai | Natural mica | TiO₂ | 10-45 |
| White | Fine | | | |
| KC9103-SW | Chemicals | | | |
| | Co., Ltd. | | | |
| Exterior Fine Gold | Fujian Kuncai | Natural mica | TiO₂ | 5-25 |
| Satin KC9201-SW | Fine | | | |
| | Chemicals | | | |
| | Co., Ltd. | | | |
| Exterior Platinum | Fujian Kuncai | Natural mica | TiO₂ | 10-45 |
| Pearl KC9205-SW | Fine | | | |
| | Chemicals | | | |
| | Co., Ltd. | | | |
| ADAMAS © | CQV Co., Ltd. | Al₂O₃ | TiO₂ | 3-30 |
| A-100D | | | | |
| ADAMAS © | CQV Co., Ltd. | Al₂O₃ | TiO₂ | 5-30 |
| A-901K | | | | |
| Splendor White | | | | |
| ADAMAS © | CQV Co., Ltd. | Al₂O₃ | TiO₂ | 9-45 |
| A-901S | | | | |
| Dazzling White | | | | |
| ADAMAS © | CQV Co., Ltd. | Al₂O₃ | TiO₂ | 5-30 |
| A-901K | | | | |
| Splendor Gold | | | | |
| ADAMAS © | CQV Co., Ltd. | Al₂O₃ | TiO₂ | 9-45 |
| A-701S | | | | |
| Dazzling Gold | | | | |
| ADAMAS © | CQV Co., Ltd. | Al₂O₃ | TiO₂ | 9-45 |
| A-741S | | | | |
| Dazzling Red | | | | |
| ADAMAS © | CQV Co., Ltd. | Al₂O₃ | TiO₂ | 5-30 |
| A-781K | | | | |
| Splendor Blue | | | | |
| ADAMAS © | CQV Co., Ltd. | Al₂O₃ | TiO₂ | 9-45 |
| A-781S | | | | |
| Dazzling Blue | | | | |
| Iriodin © 183 | Merck KGaA | Natural mica | TiO₂ | 45-500 |
| Miraval © Cosmic | Merck KGaA | Glass flake | TiO₂ | 20-200 |
| Silver | | | | |
| lriodin © 163 | Merck KGaA | Natural mica | TiO₂ | 20-180 |
| lriodin © 111 | Merck KGaA | Natural mica | TiO₂ | 1-15 |
| CHAOS © C-901M | CQV Co., Ltd. | Synthetic mica | TiO₂ | 3-17 |
| Rutile Ultra Silk | | | | |
| CHAOS © C-901D | CQV Co., Ltd. | Synthetic mica | TiO₂ | 5-25 |
| Rutile Fine White | | | | |
| CHAOS © C-900D | CQV Co., Ltd. | Synthetic mica | TiO₂ | 5-25 |
| Fine White | | | | |
| CHAOS © C-907K | CQV Co., Ltd. | Synthetic mica | TiO₂ | 5-35 |
| Skye White | | | | |
| CHAOS © C-901K | CQV Co., Ltd. | Synthetic mica | TiO₂ | 5-35 |
| Splendor White | | | | |
| CHAOS © C-901S | CQV Co., Ltd. | Synthetic mica | TiO₂ | 9-45 |
| Rutile Dazzling | | | | |
| Standard | | | | |
| CHAOS © C-900S | CQV Co., Ltd. | Synthetic mica | TiO₂ | 9-45 |
| Dazzling Standard | | | | |
| CHAOS © C-902S | CQV Co., Ltd. | Synthetic mica | TiO₂ | 9-45 |
| Super White | | | | |
| CHAOS © C-109S | CQV Co., Ltd. | Synthetic mica | TiO₂ | 9-41 |
| Super Pearl | | | | |
| CHAOS © C-109B | CQV Co., Ltd. | Synthetic mica | TiO₂ | 13-60 |
| Shimmering White | | | | |
| CHAOS © C-901E | CQV Co., Ltd. | Synthetic mica | TiO₂ | 17-100 |
| Glitter Pearl | | | | |
| Magchrom © | CQV Co., Ltd. | Natural mica | TiO₂ | 7-30 |
| N-5001C Natural | | | | |
| Corona Gold | | | | |
| Magchrom © | CQV Co., Ltd. | Natural mica | TiO₂ | 9-45 |
| N-5001S Natural | | | | |
| Dazzling Gold | | | | |

The thickness of the metal oxide, metal oxide hydrate, metal suboxide, metal, metal fluoride, metal nitride, metal oxynitride layers or a mixture thereof on the support substrate is usually 3 to 1000 nm and in the case of the metal oxide, metal oxide hydrate, metal suboxide, metal fluoride, metal nitride, metal oxynitride layers or mixtures thereof preferably 20 to 200 nm.

In a preferred embodiment, the support of the effect pigment may be coated with one or more transparent semitransparent and/or opaque layers comprising metal oxides, metal oxide hydrates, metal suboxides, metals, metal fluorides, metal nitrides, metal oxynitrides or mixtures of these materials. The metal oxide, metal oxide hydrate, metal suboxide, metal, metal fluoride, metal nitride, metal oxynitride layers or mixtures thereof can have a low refractive index (refractive index <1.8) or a high refractive index (refractive index ≥1.8). Suitable metal oxides and metal oxide hydrates are all metal oxides or metal oxide hydrates known to the person skilled in the art, such as, for example, aluminium oxide, aluminium oxide hydrate, silicon oxide, silicon oxide hydrate, iron oxide, tin oxide, cerium oxide, zinc oxide, zirconium oxide, chromium oxide, titanium oxide, in particular titanium dioxide, titanium oxide hydrate and mixtures thereof, such as, for example, ilmenite or pseudobrookite. Metal suboxides which can be employed are, for example, the titanium suboxides. A suitable metal fluoride is, for example, magnesium fluoride. Metal nitrides or metal oxynitrides which can be employed are, for example, the nitrides or oxynitrides of the metals titanium, zirconium and/or tantalum. The support is preferably coated with metal oxide, metal, metal fluoride and/or metal oxide hydrate layers and very particularly preferably metal oxide and/or metal oxide hydrate layers. Furthermore, multilayered structures comprising high- and low-refractive-index metal oxide, metal oxide hydrate, metal or metal fluoride layers may also be present, in which case high- and low-refractive-index layers preferably alternate. Particular preference is given to layer packages comprising a high-refractive-index layer and a low-refractive-index layer, where one or more of these layer packages may be applied to the support. The sequence of the high- and low-refractive-index layers can be matched to the support here in order to incorporate the support into the multilayered structure. In a further embodiment, the metal oxide, metal silicate, metal oxide hydrate, metal suboxide, metal, metal fluoride, metal nitride or metal oxynitride layers may be mixed or doped with colorants.

Suitable colorants or other elements are, for example, inorganic coloured pigments, such as coloured metal oxides, for example magnetite, chromium(III) oxide or coloured pigments such as, for example, Thénard's Blue (a Co/Al spinel), or elements such as, for example, yttrium or antimony, as well as generally pigments from the structural class of the perovskites, pyrochlors, rutiles and spinels. Pearlescent pigments comprising these layers exhibit a high colour variety with respect to their mass tone and can in many cases exhibit an angle-dependent change in the colour (colour flop) due to interference.

In this patent application, “high-refractive-index” denotes a refractive index of ≥1.8, while “low-refractive-index” denotes a refractive index of <1.8.

In a preferred embodiment, the outer layer on the support is a high-refractive-index metal oxide. This outer layer may additionally be on the above-mentioned layer packages or, in the case of high-refractive-index supports, be part of a layer package and consist, for example, of TiO₂, titanium suboxides, titanium oxynitrides, Fe₂O₃, SnO₂, ZnO, ZrO₂, Ce₂O₃, CoO, Co₃O₄, V₂O₅, Cr₂O₃ and/or mixtures thereof, such as, for example, ilmenite or pseudobrookite. TiO₂ is particularly preferred, furthermore Fe₂O₃. If the support flakes are coated with TiO₂, the TiO₂ is preferably in the rutile modification, furthermore in the anatase modification. The processes for the preparation of rutile are described in the prior art, for example in U.S. Pat. Nos. 5,433,779, 4,038,099, 6,626,989, DE 25 22 572 C2, EP 0 271 767 B1.

A thin tin oxide layer (<10 nm), which serves as additive for converting the TiO₂ into rutile, is preferably applied to the substrate flake before the TiO₂ is precipitated on.

The effect pigments are known and for the most part commercially available and can be prepared by the standard processes known to the person skilled in the art. The wet-chemical process for the preparation of the effect pigments is preferably used, it being possible to use the known wet-chemical coating technologies developed for the preparation of pearlescent pigments, as described, for example, in DE 14 67 468,

### DE 19 59 998, DE 20 09 566, DE 21 06 613, DE 22 14 545, DE 22 15 191, DE 22 44 298, DE 23 13 331, DE 24 29 762, DE 25 22 572, DE 31 37 808, DE 31 37 809, DE 31 51 343, DE 31 51 354, DE 31 51 355, DE 32 11 602, DE 32 35 017, EP 0 608 388 , WO 98/53011.

Particularly preferred effect pigments have the following structure:

substrate flake+TiO₂
substrate flake+titanium oxynitride
substrate flake+SiO₂+TiO₂
substrate flake+SnO₂+TiO₂
substrate flake+Cr₂O₃+TiO₂
substrate flake+Ce₂O₃+TiO₂
substrate flake+ZrO₂+TiO₂
substrate flake+TiO₂+Cr₂O₃
substrate flake+TiO₂+SiO₂+TiO₂
substrate flake+TiO₂+SiO₂
substrate flake+TiO₂+SnO₂+TiO₂
substrate flake+TiO₂+Fe₂O₃
substrate flake+Fe₂O₃+TiO₂
substrate flake+TiO₂+Al₂O₃+TiO₂
substrate flake+TiO₂+ZrO₂+TiO_{2.}

Very particularly preferred effect pigments have the following layer structure:

natural phyllosilicate flakes+TiO₂
natural phyllosilicate flakes+titanium oxynitrides
natural phyllosilicate flakes+TiO₂+SiO₂+TiO₂
natural phyllosilicate flakes+TiO₂+SnO₂+TiO₂
synthetic phyllosilicate flakes+TiO₂
synthetic phyllosilicate flakes+titanium oxynitrides
synthetic phyllosilicate flakes+TiO₂+SiO₂+TiO₂
synthetic phyllosilicate flakes+TiO₂+SnO₂+TiO₂
Al₂O₃ flakes+TiO₂
Al₂O₃ flakes+titanium oxynitrides
Al₂O₃ flakes+TiO₂+SiO₂+TiO₂
SiO₂ flakes+TiO₂
SiO₂ flakes+titanium oxynitrides
SiO₂ flakes+TiO₂+SiO₂+TiO₂
glass flakes+TiO₂
glass flakes+titanium oxynitrides
SiC flakes+TiO₂
SiC flakes+titanium oxynitrides
BN flakes+TiO₂
BN flakes+titanium oxynitrides
Fe₂O₃ flakes+TiO₂
Fe₂O₃ flakes+titanium oxynitrides
TiO₂ flakes+TiO₂
TiO₂ flakes+ZrO₂+TiO₂
TiO₂ flakes+SiO₂+TiO₂
titanate flakes+TiO₂
titanate flakes+ZrO₂+TiO₂
titanate flakes+SiO₂+TiO₂

Suitable effect pigments are commercially available, for example from BASF Corp., for example under the trade names Firemist®, Rightfit™, Magnapearl®, from Eckart, for example under the trade name Symic, from Merck KGaA under the trade names Iriodin®, Miraval®, Xirallic®, Pyrisma®, and Colorstream®.

In order to improve the wettability and/or compatibility with the print medium, it is frequently advisable, depending on the area of application, to subject the finished pearlescent pigment to inorganic or organic aftercoating or aftertreatment. Suitable aftercoatings or aftertreatments are, for example, the methods described in German patent 22 15 191, DE-A 31 51 354, DE-A 32 35 017 or DE-A 33 34 598. This aftercoating simplifies handling of the pigment, in particular incorporation into various media. In order to improve the wettability, dispersibility and/or compatibility with the application media, functional coatings comprising organic or combined organic/inorganic aftercoatings, for example with silanes, may be possible.

The effect pigments according to the invention have increased temperature and heat stability compared with the unstabilised effect pigments. The stabilised effect pigments can be incorporated without problems into engobes and glazes. Depending on the desired effect, the glazes can be matt to glossy, or transparent to opaque.

The coating of clay, glass and ceramic products in order to improve (prime) the surface through fineness or colour is usually carried out using ceramic coating compositions. The engobes are generally composed of a glass frit, a binder and optionally a pigment. The engobe generally comprises a frit for the firing range from 600-1200° C., where the frit is composed of constituents that are usual in frits, such as, for example, Al₂O₃, SiO₂, B₂O₃, TiO₂, ZrO₂, Sb₂O₃, P₂O₅, Fe₂O₃, alkali metal oxides and alkaline-earth metal oxides. Besides the effect pigment according to the invention, inorganic coloured pigments, such as, for example, coloured metal oxides and/or metal hydroxides selected from the group Co, Cr, Cu, Mn, Fe, Zr, V, Al, Ni, Si, Sb, Pr, Ca or CdSSe (encapsulated) and mixtures thereof, in amounts of 0 to 30% by weight, preferably 5 to 20% by weight, and in particular 5 to 15% by weight, based on the inorganic components, may furthermore be added to the frits.

Besides the effect pigments, the engobe slip may furthermore comprise a binder in amounts of 0 to 70%, preferably 10 to 60% by weight, in particular 20 to 50% by weight. The choice of binder depends on the technological requirements of the coating to be produced. Suitable binders are, in particular, all binders or binder mixtures that are usually suitable for ceramics, in particular a screen-printing medium. Thus, it is possible to employ binders based on cellulose, polyethylene glycol, cellulose nitrate, alkylcellulose, hydroxycellulose, hydroxyalkylcellulose ether, hydroxyalkylcellulose, cellulose acetopropionate, butyrate, polyacrylate, polymethacrylate, polyester, polyphenol, urea, melamine, polyterpene, polyvinyl, polyvinyl chloride, polyvinylpyrrolidone resins, polystyrene and modified polystyrene, poly-alpha-methylstyrene, esters of hydrogenated colophony, polyoefins, cumaroneindene, hydrocarbon, ketone, aldehyde, aromatic, formaldehyde resins, carbamic acid, sulfonamide, epoxy resins, polyurethanes and/or natural oils or derivatives of the said substances. It is furthermore possible to employ conventional paint binders, such as, for example, polyurethane-acrylate resins, acrylate-melamine resins, alkyd resins, polyester resins, polyurethanes, nitrocellulose, ketone resins, aldehyde resins as well as polyvinylbutyral, acrylate resins or epoxy resins and mixtures thereof as binder.

The application can, however, also be applied without a binder, for example in dust form. In this case, effect pigment and frit powder are mixed and applied dry, for example by scattering.

The solvent component in the engobe slip must be matched expertly to the respective binder if a solvent is required. Water and all organic solvents, preferably those which are emulsifiable or miscible with water, can be employed in the preparation. Suitable solvents are those which were hitherto used in the sector of ceramic coating compositions, such as pine oil, terpineol, ester alcohol, toluenes, benzines, mineral oils, aliphatic or aromatic hydrocarbons, esters, vegetable oils, aliphatic alcohols, such as those having 2 to 4 carbon atoms, for example ethanol, butanol, ester alcohols, tridecyl alcohol, isopropanol or ketones, for example acetone or methyl ethyl ketone, glycol or glycol ethers, such as, for example, tripropylene glycol methyl ether, propylene glycol monoethyl ether or diols, such as, for example, ethylene glycol and propylene glycol or polyether diols, such as, for example, polyethylene glycol and polypropylene glycol or polyols, such as, for example, aliphatic triols and tetraols having 2 to 6 carbon atoms, such as trimethylolethane, trimethylolpropane, glycerol, 1,2,4-butanetriol, 1,2,6-hexanetriol and pentaerythritol, and all other solvents from other classes of compound or mixtures of the above-mentioned solvents. Preference is given to the use of solvents which are listed in Karsten, Lackrohstofftabellen [Coating Raw Material Tables], 8th Edition 1987. In particular, use is made of solvents which are infinitely miscible with water.

The engobe generally comprises 0 to 90% by weight of water and/or an organic solvent or solvent mixture, preferably 5 to 80% by weight, in particular 20 to 70% by weight, based on the engobe slip.

As additional further constituent, the engobe slip may comprise up to 15% by weight, preferably 0.1 to 5% by weight, of one or more viscosity modifiers. Modifiers of this type are likewise known from the prior art and examples thereof are formed by ethylcellulose, nitrocellulose, hydroxypropylcellulose, hydroxypropylmethylcellulose, acrylic resins, poly(vinyl)butyral resins, carboxymethylcellulose and ethylhydroxyethylcellulose.

The engobe slip may also comprise further modifying constituents, such as, for example, dispersants, wetting agents, antisettling agents, flow aids, etc.

The engobe slip comprising the frit, optionally further additives, colourants or coloured pigments, is ground, preferably wet-ground, to a grinding fineness of 0.1-300 μm, preferably 10-20 μm. Finally, the effect pigment is mixed in.

The finished engobe slip can be applied to tiles, clay, glass or ceramic surfaces by conventional application methods, such as spraying, brushing, flooding or dipping. It can be applied to fired or unfired tiles, fired or unfired clay and ceramic products. The engobe slip is preferably applied to unfired products. The applied engobe slip is subsequently dried, preferably at 50-200° C. for 0.5-5 h. Finally, the coated product is fired at 400-1200° C. for several hours, preferably 2-48 h.

The engobe comprising the effect pigment according to the invention provides coating of clay products, for example unfired roof tiles and ceramics, such as, for example, tiles, with significantly improved optical properties with respect to colour and gloss and possibilities for novel interesting colour accents.

The effect pigments according to the invention are furthermore suitable for the preparation of flowable pigment preparations and dry preparations, in particular for printing inks and paints, preferably automobile paints, consisting of the pigments according to the invention, binders and optionally one or more additives.

The invention furthermore relates to the use of the effect pigments according to the invention in paints, coatings, printing inks, plastics, ceramic materials, glasses, for the laser marking of plastics and papers and in cosmetic formulations, in particular in printing inks. The pigments according to the invention are furthermore also suitable for the preparation of pigment preparations and for the preparation of dry preparations, such as, for example, granules, chips, pellets, briquettes, etc. The dry preparations are particularly suitable for paints and printing inks.

The invention thus also relates to formulations comprising the effect pigment according to the invention.

The following examples are intended to explain the invention, but without limiting it.

### EXAMPLES

### Example 1

100 g of Iriodin® 103 (TiO₂ mica pigment from Merck) are stirred in 2 l of demineralised water and heated to 70° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving. This gives an effect pigment with a white mass tone and high gloss which has the following particle size distribution:

### D₁₀=10 μm

### D₉₀=60 μm.

The effect pigment from Example 1, coated with SnₓSb₁₋ₓO₂, where x=0.9, is stable at temperatures >1000° C.

### Example 2

100 g of Xirallic® Crystal Silver (Al₂O₃ flakes coated with TiO₂, effect pigment from Merck) are suspended in 2 l of demineralised water and the suspension is heated to 85° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 12 h and subsequently calcined at 850° C. for 45 min. This is followed by sieving.

This gives an effect pigment with a white mass tone, very high gloss and a very intense sparkle effect which has the following particle size distribution:

### D₁₀=5 μm

### D₉₀=30 μm.

The effect pigment from Example 2, coated with SnₓSb₁₋ₓO₂, where x=0.9, is stable at temperatures >1100° C.

### Example 3

100 g of Xirallic® Miraval Cosmic Silver (glass flakes coated with TiO₂, effect pigment from Merck) are suspended in 2 l of demineralised water and the suspension is heated to 85° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 12 h and subsequently calcined at 850° C. for 45 min. This is followed by sieving. This gives an effect pigment with a white mass tone, very high gloss and a very intense sparkle effect which has the following particle size distribution:

### D₁₀=20 μm

### D₉₀=200 μm.

The effect pigment from Example 3, coated with SnₓSb₁₋ₓO₂, where x=0.9, is stable at temperatures >1000° C.

### Example 4

100 g of mica flakes (N fraction, particle size: 10-60 μm) are stirred in 2 l of demineralised water and heated to 70° C. This is followed by the metered addition of 90 g of tin(IV) chloride solution, during which the pH of 2.3 is kept constant by simultaneous dropwise addition of a 32% sodium hydroxide solution. 200 g of titanium(IV) chloride solution are then metered in, during which the pH of 1.9 is kept constant by simultaneous dropwise addition of a 32% sodium hydroxide solution. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving. This gives an effect pigment with a white mass tone and high gloss which has the following particle size distribution:

### D₁₀=10 μm

### D₉₀=60 μm.

The effect pigment from Example 4, coated with SnₓSb₁₋ₓO₂, where x=0.9, is stable at temperatures >1000° C.

### Example 5

100 g of mica flakes (F fraction, particle size: 5-25 μm) are stirred in 2 l of demineralised water and heated to 70° C. This is followed by the metered addition of 90 g tin(IV) chloride solution, during which the pH of 2.3 is kept constant by simultaneous dropwise addition of a 32% sodium hydroxide solution. 200 g of titanium(IV) chloride solution are then metered in, during which the pH of 1.9 is kept constant by simultaneous dropwise addition of a 32% sodium hydroxide solution. This is followed by the metered addition of 30 g of a 32% antimony(III) chloride solution and 160 g of a 50% tin chloride solution, during which the pH of 3.0 is kept constant by simultaneous drop-wise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving.

This gives an effect pigment having a white mass tone and moderate gloss which has the following particle size distribution:

### D₁₀=5 μm

### D₉₀=25 μm.

The effect pigment from Example 5, coated with SnₓSb₁₋ₓO₂, where x=0.9, is stable at temperatures >1000° C.

### Example 6

100 g of Iriodin® 100 (mica flakes coated with TiO₂, effect pigment from Merck) are stirred in 2 l of demineralised water and heated to 70° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 1000° C. for 30 min. This is followed by sieving.

This gives an effect pigment having a white mass tone and high gloss which has the following particle size distribution:

### D₁₀=10 μm

### D₉₀=60 μm.

The effect pigment from Example 6, coated with SnₓSb₁₋ₓO₂, where x=0.9, is stable at temperatures >1000° C.

### Example 7

100 g of Iriodin® 123 (mica flakes coated with TiO₂, effect pigment from Merck) are stirred in 2 l of demineralised water and heated to 70° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving.

This gives an effect pigment having a white mass tone and moderate gloss and sparkle effect which has the following particle size distribution:

### D₁₀=5 μm

### D₉₀=25 μm.

The effect pigment from Example 7, coated with SnₓSb₁₋ₓO₂, where x=0.9, is stable at temperatures >1000° C.

### Example 8

100 g of Iriodin® 6163 (synthetic mica flakes coated with TiO₂, effect pigment from Merck) are suspended in 2 l of demineralised water and the suspension is heated to 85° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 12 h and subsequently calcined at 850° C. for 45 min. This is followed by sieving.

This gives an effect pigment having a white mass tone, high gloss and a high sparkle effect which has the following particle size distribution:

### D₁₀=20 μm

### D₉₀=180 μm.

The effect pigment from Example 8, coated with SnₓSb₁₋ₓO₂, where x=0.9, is stable at temperatures >1000° C.

### Example 9

100 g of Colorstream® Viola Fantasy (SiO₂ flakes coated with TiO₂, effect pigment from Merck) are suspended in 2 l of demineralised water and the suspension is heated to 85° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 12 h and subsequently calcined at 850° C. for 45 min. This is followed by sieving.

This gives an effect pigment having a white mass tone, very high gloss and a colour flop which has the following particle size distribution:

### D₁₀=5 μm

### D₉₀=50 μm.

The effect pigment from Example 9, coated with SnₓSb₁₋ₓO₂, where x=0.9, is stable at temperatures >1000° C.

### Example 10

100 g of Iriodin® 183 (mica flakes coated with TiO₂, effect pigment from Merck) are stirred in 2 l of demineralised water and heated to 70° C. This is followed by the metered addition of 30 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 1000° C. for 30 min. This is followed by sieving.

This gives an effect pigment having a white mass tone, high gloss and an intense sparkle effect which has the following particle size distribution:

### D₁₀=45 μm

### D₉₀=500 μm.

The effect pigment from Example 10, coated with SnₓSb₁₋ₓO₂, where x=0.9, is stable at temperatures >1000° C.

### Example 11

100 g of Iriodin® 103 (TiO₂ mica pigment from Merck) are stirred in 2 l of demineralised water and heated to 70° C. This is followed by the metered addition of 60 g of a 32% antimony(III) chloride solution and 160 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving.

This gives an effect pigment having a white mass tone and high gloss which has the following particle size distribution:

### D₁₀=10 μm

### D₉₀=60 μm.

The effect pigment from Example 11, coated with SnₓSb₁₋ₓO₂, where x=0.8, is stable at temperatures >1000° C.

### Example 12

100 g of Iriodin® 103 (TiO₂ mica pigment from Merck) are stirred in 2 l of demineralised water and heated to 70° C. This is followed by the metered addition of 30 g of a 32% antimony(III) chloride solution and 50 g of a 50% tin chloride solution, during which the pH of 3.0 is kept constant by simultaneous dropwise addition of a 32% sodium hydroxide solution. When the addition is complete, the mixture is stirred for a further 30 min. The product is filtered off, washed, dried at 110° C. for 10 h and subsequently calcined at 850° C. for 30 min. This is followed by sieving.

This gives an effect pigment having a white mass tone and high gloss which has the following particle size distribution:

### D₁₀=10 μm

### D₉₀=60 μm.

The effect pigment from Example 12, coated with SnₓSb₁₋ₓO₂, where x=0.7, is stable at temperatures >1000° C.

The improved stability of the pigments prepared in Examples 1-12 is in each case shown by the application-specific test compared with the unstabilised pigment. To this end, the unstabilised pigment (for example Iriodin® 103 in Example 1) and the pigment stabilised in each case is used in the same way and the two workpieces are assessed visually with respect to their colour and their pearlescence effect. The stabilised pigments in each case show less discolouration and a better pearlescence effect compared with the corresponding standard commercial or unstabilised effect pigment.

Use for screen printing on porcelain workpieces, which is divided into 3 steps, may be given here as representative.

### 1) Preparation of the Printing Paste

For the production of fine colour screens and relief-like prints on ceramic substrates by means of ceramic inks, use is made of screen-printing oils which prevent flow of the ink pastes of the printing and give rise to prints with sharp contours. To this end, use is made of additions to the known binders which consist of finely divided natural or synthetic waxes and/or finely divided inorganic silicate or oxidic substances which are capable of incorporation into the silicate framework of the fluxing agent. The pearlescent pigment with the corresponding amount of frit and the printing medium (screen printing oil 221-ME and Screenprint Bulk 803035 MR—both standard commercial products from Ferro—were employed in the examples) are weighed out and homogenised for a series of experiments.

The effect pigment from Examples 1 to 10 is weighed out and homogenised with the corresponding amount of frit of the following composition

| Frit | CaO | Na₂O | K₂O | BaO | Al₂O₃ | SiO₂ | B₂O₃ |
|---|---|---|---|---|---|---|---|
| % by wt. | 9.7 | 5.2 | 1.1 | 1.3 | 10.1 | 69.6 | 3.0 |

The following steps are independent of the composition of the printing paste.

### 2) Printing of Tiles

The printing paste obtained can be applied to tiles by standard printing processes, slip processes, spray application or transfer printing. In all cases, the printed tile is dried at temperatures of 60-110° C. in a drying cabinet or fume hood in order to evaporate off the solvent present in the printing oil. In the examples according to the invention, the printing paste is applied to the tiles by means of knife coater and printing screen.

### 3) Firing of the Printed Tiles

The printed and dried tile is then fired in the firing oven by means of a temperature profile.

180 min: heating to 1100° C.,
3 min: holding at 1100° C.,
120 min: rapid cooling to 600° C.,
300 min: slow cooling to room temperature.

1. Effect pigment based on a flake-form substrate, characterised in that the pigment has on the surface a top layer comprising one or more tin/antimony mixed oxides.

2. Effect pigment according to claim 1, characterised in that the effect pigment has on the surface a top layer comprising SnₓSb₁₋ₓO₂ and x is a number between 0 and 1.

3. Effect pigment according to claim 1, characterised in that the top layer is in the cassiterite structure.

4. Effect pigment according to claim 1, characterised in that the top layer is 1-100% by weight based on the entire pigment.

5. Effect pigment according to claim 1, characterised in that the top layer has a thickness of 1-500 nm.

6. Effect pigment according to claim 1, characterised in that the effect pigment is selected from the group of the pearlescent pigments, interference pigments, multilayered pigments or holographic pigments.

7. Effect pigment according to claim 1, characterised in that the effect pigment is based on natural or synthetic mica flakes, muscovite flakes, sericite flakes, fluorophlogopite flakes, Zn phlogopite flakes, SiO₂ flakes, glass flakes, TiO₂ flakes, flake-form BN, flake-form SiC, Al₂O₃ flakes or titanate flakes.

8. Effect pigment according to claim 1, characterised in that the effect pigment comprises at least one TiO₂ layer and/or at least one titanium oxynitride layer on the flake-form substrate.

9. Effect pigment according to claim 1, characterised in that the effect pigment has the following structure, plus the top layer:
substrate flake+TiO₂
substrate flake+titanium oxynitride
substrate flake+SiO₂+TiO₂
substrate flake+SnO₂+TiO₂
substrate flake+Cr₂O₃+TiO₂
substrate flake+Ce₂O₃+TiO₂
substrate flake+ZrO₂+TiO₂
substrate flake+TiO₂+Cr₂O₃
substrate flake+TiO₂+SiO₂+TiO₂
substrate flake+TiO₂+SiO₂
substrate flake+TiO₂+SnO₂+TiO₂
substrate flake+TiO₂+Fe₂O₃
substrate flake+Fe₂O₃+TiO₂
substrate flake+TiO₂+Al₂O₃+TiO₂
substrate flake+TiO₂+ZrO₂+TiO₂

10. Effect pigment according to claim 1, characterised in that the effect pigment is selected from the following group of effect pigments, plus the top layer:
natural phyllosilicate flakes+TiO₂
natural phyllosilicate flakes+titanium oxynitrides
natural phyllosilicate flakes+TiO₂+SiO₂+TiO₂
natural phyllosilicate flakes+TiO₂+SnO₂+TiO₂
synthetic phyllosilicate flakes+TiO₂
synthetic phyllosilicate flakes+titanium oxynitrides
synthetic phyllosilicate flakes+TiO₂+SiO₂+TiO₂
synthetic phyllosilicate flakes+TiO₂+SnO₂+TiO₂
Al₂O₃ flakes+TiO₂
Al₂O₃ flakes+titanium oxynitrides
Al₂O₃ flakes+TiO₂+SiO₂+TiO₂
SiO₂ flakes+TiO₂
SiO₂ flakes+titanium oxynitrides
SiO₂ flakes+TiO₂+SiO₂+TiO₂
glass flakes+TiO₂
glass flakes+titanium oxynitrides
SiC flakes+TiO₂
SiC flakes+titanium oxynitrides
BN flakes+TiO₂
BN flakes+titanium oxynitrides
Fe₂O₃ flakes+TiO₂
Fe₂O₃ flakes+titanium oxynitrides
TiO₂ flakes+TiO₂
TiO₂ flakes+ZrO₂+TiO₂
TiO₂ flakes+SiO₂+TiO₂
titanate flakes+TiO₂
titanate flakes+ZrO₂+TiO₂
titanate flakes+SiO₂+TiO₂

11. Process for the preparation of the effect pigments according to claim 1, comprising applying the tin/antimony mixed oxide layer to the effect pigment by wet-chemical methods or by chemical or physical gas-phase coating.

12. A composition for paints, coatings, printing inks, plastics, ceramic materials, glasses, for the laser marking of plastics and papers, in cosmetic formulations, for the preparation of pigment preparations or for dry preparations, comprising an effect pigment according to claim 1.

13. A composition for ceramic bodies, ceramic colours, glazes, engobes, enamels or glass, comprising an effect pigment according to claim 1.

14. A pigment formulation comprising the effect pigment according to claim 1.
